(19) United States
(12) Patent Application Publication
(10) Pub. No.: US 2012/0214075 A1
(43) Pub. Date: Aug. 23, 2012

(54) ELECTROCHEMICAL CELL HAVING AIR CATHODE PARTIALLY INFUSED WITH CARBON DIOXIDE

(75) Inventors: Lonnie G. Johnson, Atlanta, GA (US); John S. Flanagan, Chamblee, GA (US); Tedric D. Campbell, Lithia Springs, GA (US)

(73) Assignee: EXCELLATRON SOLID STATE LLC, Atlanta, GA (US)

(21) Appl. No.: 13/031,556

(22) Filed: Feb. 21, 2011

(51) Int. Cl. H01M 12/06

(52) U.S. Cl. 429/405

(57) ABSTRACT

An electrochemical cell has a cell assembly that has an anode, an air cathode infused with a liquid electrolyte, an ionically-conductive separator medium disposed between and coupling said anode and said air cathode, a housing enclosing said anode, said cathode, and said ionically-conductive separator medium, and a mixture of oxygen and carbon dioxide disposed within said housing in gaseous communication with said air cathode, wherein said carbon dioxide comprises from about 0.04% to about 95% molar fraction of said mixture of oxygen and carbon dioxide.

### RELATED APPLICATIONS

Not applicable.

### TECHNICAL FIELD

This invention relates to electrochemical cells, and more particularly, the invention relates to an electrochemical cell having an air cathode partially infused with carbon dioxide.

### BACKGROUND OF THE INVENTION

An electrochemical device converts chemical energy into electrical energy. Electrochemical devices are useful because they provide stored electrical energy that can be used to energize a multitude of devices, from small-scale type devices such as hearing aids, phones, watches and miniature cameras to large-scale articles such as dwellings, air-travel vehicles and land-travel vehicles. A battery cell is an extremely useful electrochemical cell. A battery cell is typically formed of an electrolyte medium disposed between a pair of spaced-apart electrodes.

Rechargeable battery cells are battery cells in which the active anode and active cathode materials are not irreversibly depleted during a discharge cycle but can be restored during a charging cycle. Thus rechargeable battery cells are extremely useful as a source of electrical power that can be replenished.

It is desirable to have electrochemical cells, including battery cells, which produce as much energy as possible. The energy that is and that can be provided by an electrochemical cell is typically described in terms such as “energy density,” “specific energy,” “discharge capacity,” and “discharge voltage.” Energy density is defined as the ratio of the energy available from a battery to its volume generally expressed in units of Watt-hours per Liter (Wh/L). Specific energy is defined as the ratio of energy output of a cell to its weight in units of Watt-hours per kilogram (Wh/kg). These definitions may be found in Handbook of Batteries, Third Edition, David Linden and Thomas B. Reddy editors, published by McGraw-Hill. Discharge capacity is used to describe the current that can be delivered by a cell and is expressed in Ampere-hours (A-h). Discharge voltage is used to describe the voltage that can be delivered by a cell and is expressed in Volts (V).

Energy density, specific energy, discharge capacity and discharge voltage are determined by the anode and cathode materials and electrolyte of the cell. Improving one of more of these materials or the interaction among these materials will improve cell performance. Thus it can be appreciated that it would be useful to have an electrochemical cell whose performance is improved through the use of improved interaction of cell components.

Lithium is a highly desirable material for use in an electrochemical cell such as a primary or secondary battery cell. One reason that lithium is desirable for use in a cell is that lithium is the lightest metal and, furthermore, is the third lightest element. Another reason that lithium is a preferred cell component is that lithium has one of the highest energy-producing capabilities of all elements and the highest of metals. Lithium has the highest theoretical voltage and the highest theoretical energy capacity of any metal material. The Handbook of Batteries lists the theoretical electrochemical equivalence of lithium as 3861 mAh/gram. Thus lithium as an anode has the dual desired traits of being extremely light-weight and possessing very high energy capability.

In order to obtain the maximum energy capability from a cell having a lithium anode, it is desirable to pair lithium as an anode material with an effective cathode. Oxygen is an effective cathode reactant. Oxygen used as the cathode reactant with lithium anode produces a substantial cell voltage. In addition, oxygen is light-weight in and of itself and can be derived from air when needed. Oxygen also may be supplied by an oxygen tank. A lithium/oxygen battery provides a cathode structure at which oxygen reacts with lithium-ions that are transported through the electrolyte during discharge. The reduced material resides at the cathode structure until recharging the battery returns the lithium ions back to the anode through the electrolyte. A battery cell of this type is referred to alternately as a lithium/oxygen battery or lithium/air battery because oxygen for the cathode reaction may be provided as oxygen molecules alone or oxygen as a constituent of air. While lithium/oxygen battery technology offers high specific energy density, there is room for further improvement in specific energy by achieving discharge potential and specific energy that are closer to their theoretical values. Thus because of the tremendous energy-producing potential of lithium/air battery cells, it can be appreciated that a lithium/air battery whose performance is enhanced would be extremely useful.

### SUMMARY OF THE INVENTION

According to the present invention, the performance of an electrochemical cell is enhanced by providing an air cathode and an anode coupled to one another and spaced apart by an ionically-conductive separator medium. The separator medium is ion conductive but inhibits the conduction of electrons. The cathode is electron-conductive and is infused with a liquid electrolyte. The anode, air cathode and separator medium are enclosed within a housing containing oxygen and carbon dioxide that are in gaseous communication with the air cathode. In an aspect of the embodiment, carbon dioxide comprises from about 0.04% to about 95% molar fraction of the mixture of oxygen and carbon dioxide.

According to an embodiment of the invention, a lithium-air cell comprises a lithium-based anode and an air-cathode coupled to one another and spaced apart by an ionically-conductive separator medium. The ionically-conductive separator medium is ion conductive but inhibits the conduction of electrons. The air cathode is electron conductive and is infused with an organic-solvent-based liquid electrolyte including a lithium salt. The anode, air cathode and separator medium are enclosed within a housing containing oxygen and carbon dioxide that are in gaseous communication with the air cathode. In an aspect of the embodiment, carbon dioxide comprises from about 0.04% to about 95% molar fraction of the mixture of oxygen and carbon dioxide.

According to an embodiment of the present invention a lithium/air cell is infused with carbon dioxide to aid in the reaction at the cathode. In an aspect of the invention, carbon dioxide is made available by enclosing the cell components in a sealed container where a mixture of oxygen (and/or air) plus carbon dioxide is placed in gaseous communication with the air cathode of the cell.

### BRIEF DESCRIPTION OF THE DRAWINGS

FIG. 1 is a schematic illustration of an embodiment of an enclosed electrochemical cell in accordance with the present invention.

FIG. 2 is a detailed schematic illustration of the interior cell assembly components of the enclosed electrochemical cell of FIG. 1.

### DETAILED DESCRIPTION

Embodiments of the present invention are described herein. The disclosed embodiments are merely exemplary of the invention that may be embodied in various and alternative forms, and combinations thereof. As used herein, the word “exemplary” is used expansively to refer to embodiments that serve as illustrations, specimens, models, or patterns. The figures are not necessarily to scale and some features may be exaggerated or minimized to show details of particular components. In other instances, well-known components, systems, materials, or methods have not been described in detail in order to avoid obscuring the present invention. Therefore, at least some specific structural and functional details disclosed herein are not to be interpreted as limiting, but merely as a basis for the claims and as a representative basis for teaching one skilled in the art to variously employ the present invention.

### Overview

As an overview, the invention enhances performance of a cell having an air cathode, and in particular, a lithium-air battery, by adding carbon dioxide to the air or oxygen that is used as the reactant at the cathode. The terms lithium/air and lithium/oxygen are interchangeable. In addition, this type or cell may be written with “hyphen” punctuation as lithium-air and lithium-oxygen, and without any punctuation as “lithium air” and “lithium oxygen.” These terms are used interchangeably herein.

Lithium metal offers the highest possible theoretical energy density for any battery material, namely, 11,970 Wh/kg. This energy density compares favorably to gasoline (approximately 13,000 Wh/kg). Lithium-air batteries combine a lithium metal anode (having the highest energy density of any element) with an air cathode (using oxygen in ambient air or pure oxygen as the cathode reactant, thus adding minimal mass). The predominant electrochemical reactions of lithium with oxygen are given by the equations:

2Li+O₂→Li₂O₂E^{o}=3.10V (1)

4Li+O₂→2Li₂OE^{o}=2.91V (2)

However, the discharge capacity of lithium air cells using a nonaqueous liquid electrolyte is limited by the eventual build-up of discharge products in the gas electrode used as the cathode, primarily lithium peroxide and lithium oxide. While the open circuit voltage is rather high, the discharge potential of the cell is generally lower than the theoretical value, resulting in less than the full theoretical energy density being achieved.

In accordance with the invention, the addition of carbon dioxide to the oxygen gas used in the cell has been found to increase the discharge potential, the specific capacity and the specific energy. It is believed that carbon dioxide increases the solubility of oxygen in the electrolyte and/or increases the solubility of reaction products, namely, lithium peroxide and possibly lithium oxide, in the liquid electrolyte of a lithium-air cell. The improvements in solubility result in increases in the reaction rates within the cell.

Although the term “battery” technically may more properly define a combination of two or more cells, it has come to be used popularly to refer to a single cell as well. Thus the term battery by itself is sometimes for convenience of explanation used herein to refer to what is actually a single cell. The teachings herein that are applicable to a single cell are applicable equally to each cell of a battery containing multiple cells.

Referring now to the drawings, wherein like numerals indicate like elements throughout the several views, the drawings illustrate certain of the various aspects of exemplary embodiments.

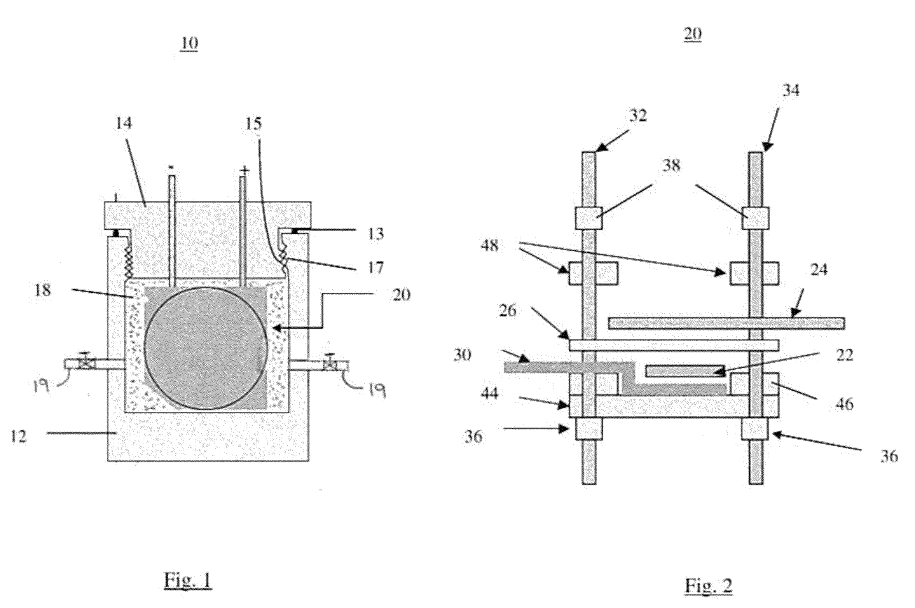

Referring first to FIG. 1, therein is illustrated a schematic representation of an embodiment of an enclosed electrochemical cell 10 according to the teachings of the present invention. A vessel 12 having a sealable cover 14 encloses a cell assembly 20. Although the vessel 12 and cover 14 may be sealable by several methods known in the art, an O-ring type of seal 15 is suitable particularly if the vessel 12 and cover 14 may be interconnected by respective complementary screw threads 15, 17. One or more closeable inlet ports 19 are used to infuse oxygen, air, or carbon dioxide, or a mixture of oxygen and/or air and carbon dioxide. For example, when two ports 19, are used one may be used to input oxygen or air while the other may be used to input carbon dioxide. As another example, one port 19 may be used to inlet a mixture of oxygen (or air) and the carbon dioxide in predetermined percentages by volume. When air is used, it is preferable to pre-dry the air to remove moisture, particularly if the cell is to be reversible.

Referring now to FIG. 2, therein is illustrated a schematic representation of an embodiment of a cell assembly 20 of the enclosed electrochemical cell of FIG. 1 in accordance with the teachings of the invention. In this schematic representation, the components of the cell assembly are shown in a manner that facilitates an understanding of the relationship and interaction between components but that does not necessarily depict an actual configuration of a particular component. An anode 22 and an air cathode 24 are spaced apart from one another and coupled to one another by an ionically-conductive separator medium 26. The air cathode is wetted, or infused, with a liquid electrolyte. The ionically-conductive separator medium 26 includes a separator structure that physically separates the anode and cathode from one another while also abutting the two. The separator medium is ionically-conductive because the separator structure either contains a liquid electrolyte or is a solid electrolyte, or is an ionically-conductive separator structure that also contains a liquid electrolyte. A copper current collector 30 is disposed adjacent and collects current from the anode 22. The copper current collector 30, in turn, is connected to a copper current collector rod 32, which serves as an anode terminal for an external circuit. A nickel current collector rod 34 is connected to the cathode 24 and serves as a cathode connecting point for an external circuit. Lower nuts 36 and upper nuts 38 help secure the positioning of some of the cell assembly components in the enclosure. A non-electronically-conductive supporting structure such as a Teflon® plastic polymer block rests upon the lower nuts 36. Teflon® is a trademark registered in the United States Patent and Trademark Office and is owned by E.I. Du Pont De Nemours and Company, a Corporation of Delaware having an address at 1007 Market Street, Wilmington, Del. 19898. Spacers 46, 48 further help to facilitate positioning of the components of the cell assembly.

Production of Electrochemical Cell in Accordance with the Teachings of the Invention

An oxygen (or air) cathode for a lithium oxygen or lithium air cell is prepared from a slurry. The slurry is comprised of carbon powder and a catalyst such as a phosphate or oxide that is based upon cations of materials such as copper, gallium, manganese, cobalt and iron suspended in a solution of polymer binder. Examples of suitable catalysts are MnO₂ and Fe₃O₄. Suitable polymer binders are polyvinylidene fluoride (PVDF), polytetrafluoroethylene (PTFE) or carboxymethyl cellulose (CMC) dissolved in a suitable solvent such as acetone, alcohols, or water. The mixture of carbon powder, catalyst and binder is milled to ensure thorough mixing and interparticle contacts. A cathode is formed by casting the slurry onto a carbon fiber mesh and allowing the solvent to evaporate. Various heating methods may be used to accelerate evaporation. The cathode is then placed in contact with a separator structure such as a membrane. Suitable separators are the membrane-type battery separator sold by Celgard under the brand name Celgard® and membranes made of porous polyimide material. Celgard® is a trademark registered in the United States Patent and Trademark Office and is owned by Celgard, LLC, a limited liability company (LLC) of Delaware having a business address at 4838 Jenkins Avenue, North Charleston, S.C. 29405. The cathode is wetted, or infused, with nonaqueous liquid electrolyte such as a lithium salt dissolved in propylene carbonate. Instead of using a nonaqueous liquid electrolyte, the cathode may be wetted, or infused, with an ionic liquid or a blend of two or more ionic liquids. The separator membrane is a separator structure that is a part of the separator medium. The separator medium is ionically conductive. The separator medium is made to be ionically conductive in manners which include (a) the separator structure is wetted, or infused, with liquid electrolyte, or (b) the separator structure/membrane is made of ionically-conductive material, or (c) the separator structure/membrane is made of ionically-conductive material and in addition is wetted, or infused, with liquid electrolyte. The liquid electrolyte that is used to wet, or infuse, the separator structure and/or air cathode is nonaqueous when the anode is lithium-based to prevent undesirable reaction between water and lithium. The liquid electrolyte may be a solvent having a lithium salt dissolved therein. The liquid electrolyte may be an organic-solvent-based electrolyte including a lithium slat. In addition, the liquid electrolyte may be an ionic liquid such as a molten salt or a molten salt dissolved in a suitable solvent. The liquid electrolyte may be an ionic liquid having a lithium salt dissolved therein. A lithium-based anode such as a lithium metal anode or lithium-intercalated anode is placed on the opposite side of the separator structure and pressed into a copper foil or mesh current collector. The assembled components are placed into an enclosure that can be filled with a gas. The enclosure is fitted with gas-tight electrical leads and filled with gaseous oxygen and carbon dioxide mixture. The cell is then discharged and charged through the external leads.

The invention teaches infusion of a mixture of oxygen and carbon dioxide wherein carbon dioxide comprises from about 0.04% to about 95% molar fraction of the mixture. It is noted that the partial pressure of carbon dioxide may be sufficiently high so as to establish a super-critical or sub-critical thermodynamic state.

Example of Production of Electrochemical Cell in Accordance with the Teachings of the Invention

Air cathodes were produced and arranged for testing as follows:
1. The cathode slurry was prepared by mechanically blending solid material comprising 67.5% by weight carbon powder, 20.9% by weight Kynar® brand polyvinylidene fluoride (PVDF) as binder and 11.6% by weight cobalt oxide (Co₃O₄) as catalyst in a suitable solvent for a period of 4 hours. Milling was performed on a planetary type mill apparatus running at 300 rpm for 4 hours. Kynar® is a trademark registered in the United States Patent and Trademark Office and is owned by Arkema, Inc., a Pennsylvania corporation, having an address at 2000 Market Street, Philadelphia, Pa. 19103. The solvent used was acetone (CH₃COCH₃).
2. The wet slurry was cast on nonwoven carbon fiber, dried and cut into 1 cm² active area pieces. The nonwoven carbon fiber had a mesh configuration. In addition to serving as a supporting substrate for slurry, it also served as the cathode current collector in the finally-formed cathode structure.
3. For electrochemical testing, the cathode was placed onto the positive terminal and then wetted with about 60 microliters (μL) of liquid electrolyte. The liquid electrolyte was 1M lithium trifluoromethanesulfonimide (LiTFSI) in a solution of propylene carbonate (PC) and tetraglyme mixed in a 1:2 ratio by weight and to which was added 2% by weight vinyl carbonate (VC).
4. A suitable separator (Celgard® C5550) was placed in contact with the cathode and an opposing lithium-metal anode adjoined to a copper current collector. The copper current collector was in contact with the negative terminal of the cell.
5. The cell-components assembly (cathode with integrally-formed carbon mesh cathode current collector, separator, anode, and anode current collector) was enclosed in an air-tight vessel fitted with terminals and a gas port.
6. The vessel was flushed and filled with pure O₂ and then backfilled with CO₂. Flushing and filling with O₂ removed gases that were present in the vessel even if they were not considered detrimental. This helped to create a controlled gaseous environment within the vessel. The cathode was disposed on the cell so as to be exposed to and in fluid communication with gases infused in the vessel. After flushing, the vessel was pressurized with O₂ to a pressure of 5 psi. To achieve a 50:50 O₂—CO₂ gaseous mix, carbon dioxide was injected until a pressure equal to that of the oxygen (O₂) pressure (5 psi) was achieved. Testing was conducted with the vessel containing pure oxygen (O₂) and with the vessel containing the 50:50 oxygen-carbon dioxide mix.

Cells with 1 cm² cathodes were assembled and tested using an atmosphere of pure oxygen and a 50:50 mixture by volume of oxygen and carbon dioxide. The cells were tested by repeatedly discharging and charging the cells on an automated battery tester. The primary discharge capacity and discharge voltage were measured and compared for the two groups. The cells that were tested in the 50:50 CO₂:O₂ mixture exhibited higher primary discharge voltage and higher primary capacity than cells tested in pure O₂.

TABLE 1
Primary discharge capacities and primary discharge voltages for cells
with 50:50 oxygen-carbon dioxide mix (denoted in the table as CO₂)
and pure oxygen (denoted in the table as O₂).

| Group | Primary Capacity (Ah) | Discharge Voltage (V) |
|---|---|---|
| CO₂ | 0.00388 | 2.57 |
| CO₂ | 0.00063 | 2.13 |
| CO₂ | 0.00098 | 2.44 |
| CO₂ | 0.00473 | 2.47 |
| CO₂ | 0.00439 | 2.50 |
| CO₂ | 0.00430 | 2.51 |
| CO₂ | 0.00115 | 2.28 |
| CO₂ | 0.00583 | 2.47 |
| CO₂ | 0.00351 | 2.39 |
| CO₂ | 0.00278 | 2.43 |
| CO₂ | 0.00468 | 2.45 |
| CO₂ | 0.00220 | 2.46 |
| CO₂ | 0.00396 | 2.44 |
| CO₂ | 0.00459 | 2.45 |
| CO₂ | 0.00136 | 2.35 |
| CO₂ | 0.00214 | 2.39 |
| O₂ | 0.00055 | 2.14 |
| O₂ | 0.00085 | 2.22 |
| O₂ | 0.00126 | 2.26 |
| O₂ | 0.00152 | 2.28 |
| O₂ | 0.00100 | 2.25 |
| O₂ | 0.00137 | 2.27 |
| O₂ | 0.00174 | 2.32 |
| O₂ | 0.00142 | 2.26 |
| O₂ | 0.00166 | 2.26 |
| O₂ | 0.00299 | 2.31 |
| O₂ | 0.00268 | 2.32 |
| O₂ | 0.00175 | 2.26 |
| O₂ | 0.00160 | 2.27 |
| O₂ | 0.00152 | 2.26 |
| O₂ | 0.00198 | 2.27 |
| O₂ | 0.00172 | 2.25 |

The enhancement of cell performance due to CO₂ has several advantages. The higher voltage and the higher capacity both result in increases to the cell's specific energy. In addition, tolerance of CO₂ is of great advantage for cells designed to operate on oxygen from the ambient air, bypassing the need to equip such a cell with a scrubber to remove carbon dioxide, which is naturally present in air.

Many variations and modifications may be made to the above-described embodiments without departing from the scope of the claims. All such modifications, combinations, and variations are included herein by the scope of this disclosure and the following claims.

1. An electrochemical cell comprising:
an anode,
an air cathode infused with a liquid electrolyte,
an ionically-conductive separator medium disposed between and coupling said anode and said air cathode,
a housing enclosing said anode, said cathode, and said ionically-conductive separator medium, and
a mixture of oxygen and carbon dioxide disposed within said housing in gaseous communication with said air cathode;
wherein said carbon dioxide comprises from about 0.04% to about 95% molar fraction of said mixture of oxygen and carbon dioxide.

2. The electrochemical cell of claim 1, wherein said mixture of oxygen and carbon dioxide comprises about 50% each by volume.

3. The electrochemical cell of claim 1, wherein said oxygen comprises oxygen as a constituent of air.

4. The electrochemical cell of claim 1, further comprising at least one of an anode current collector adjoining said anode and a cathode current collector adjoining said cathode.

5. The electrochemical cell of claim 1, wherein said housing further comprises at least one gas inlet port for receiving said oxygen and said carbon dioxide.

6. The electrochemical cell of claim 1, wherein said liquid electrolyte comprises a solvent having a lithium salt dissolved therein.

7. The electrochemical cell of claim 1, wherein said liquid electrolyte comprises an organic-solvent-based electrolyte including a lithium salt.

8. The electrochemical cell of claim 1, wherein said liquid electrolyte comprises an ionic liquid.

9. The electrochemical cell of claim 1, wherein said liquid electrolyte comprises an ionic liquid having a lithium salt dissolved therein.

10. The electrochemical cell of claim 1, wherein said ionically-conductive separator medium comprises a separator structure infused with a liquid electrolyte.

11. The electrochemical cell of claim 10, wherein said liquid electrolyte comprises a solvent having a lithium salt dissolved therein.

12. The electrochemical cell of claim 10, wherein said liquid electrolyte comprises an organic-solvent-based electrolyte including a lithium salt.

13. The electrochemical cell of claim 10, wherein said liquid electrolyte comprises an ionic liquid.

14. The electrochemical cell of claim 10, wherein said liquid electrolyte comprises an ionic liquid having a lithium salt dissolved therein.

15. The electrochemical cell of claim 1, wherein said ionically-conductive separator medium comprises an ionically-conductive separator structure.

16. The electrochemical cell of claim 15, wherein said ionically-conductive separator structure is infused with a liquid electrolyte.

17. The electrochemical cell of claim 16, wherein said liquid electrolyte comprises a solvent having a lithium salt dissolved therein.

18. The electrochemical cell of claim 16, wherein said liquid electrolyte comprises an organic-solvent-based electrolyte including a lithium salt.

19. The electrochemical cell of claim 16, wherein said liquid electrolyte comprises an ionic liquid.

20. The electrochemical cell of claim 16, wherein said liquid electrolyte comprises an ionic liquid having a lithium salt dissolved therein.

21. The electrochemical cell of claim 1, wherein said anode is lithium-based and said liquid electrolyte comprises a solvent having a lithium salt dissolved therein.

22. The electrochemical cell of claim 1, wherein said anode is lithium-based and wherein said liquid electrolyte comprises an organic-solvent-based electrolyte including a lithium salt.

23. A method for operating an electrochemical cell comprising:
providing an enclosed cell assembly comprising
an anode,
an air cathode having a liquid electrolyte infused therein,
an ionically-conductive separator medium disposed between and coupling said anode and said air cathode,
a housing enclosing said anode, said air cathode, said ionically-conductive separator medium; and
selectively providing a mixture of oxygen and carbon dioxide to an interior of said housing so as to be in gaseous communication with said air cathode;
wherein said carbon dioxide comprises from about 0.04% to about 95% molar fraction of said mixture of oxygen and carbon dioxide.

24. The method of claim 23, wherein said mixture of oxygen and carbon dioxide comprises a ratio of about 50% each by volume.

25. The method of claim 23, wherein said oxygen comprises air having said oxygen as a constituent thereof.
